(19) United States
(12) Patent Application Publication
(10) Pub. No.: US 2005/0120294 A1
(43) Pub. Date: Jun. 2, 2005

(54) Systematic review system

(76) Inventors: Ian Henry Stefanison, Ottawa (CA); Peter Andrew O'Blenis, Manotick (CA)

Correspondence Address: LADAS & PARRY LLP, 224 SOUTH MICHIGAN AVENUE, SUITE 1200, CHICAGO, IL, 60604, US

(21) Appl. No.: 10/910,111

(22) Filed: Jul. 30, 2004

Related U.S. Application Data
(60) Provisional application No. 60/491,065, filed on Jul. 30, 2003.

(51) Int. Cl. G06F 17/00

(52) U.S. Cl. 715/506

(57) ABSTRACT

A system and method for systematic review of a set of documents is disclosed that permits creation of formal review schemas and associated review forms, and the automatic collection and tabulation of review results corresponding to reviewer responses. Using the system, a review study administrator creates a review schema as a series of screening and data extraction levels, each level having an associated review form. Input from reviewers are collected in a relational database as each reviewer completes the review form. Thereafter, statistical tools or other analytic software application may be applied to further process the extracted results. In some embodiments, provision is made for flagging documents with conflicting review conclusions for reconciliation. The systematic review system is particularly useful for reducing the costs associated with document publication, dissemination, and collection, and the errors and time delays inherent to manual results tabulation of review systems known in the art.

### RELATED U.S. APPLICATION DATA

Provisional Application No. 60/491,065 filed on Jul. 30, 2003, the contents of which are hereby incorporated by reference.

### FIELD OF THE INVENTION

The present invention relates to a systematic review system and is particularly concerned with a system for supporting subject matter experts review of identified pieces of literature in order to screen out irrelevant documents and to subsequently extract core data from the relevant documents.

### BACKGROUND OF THE INVENTION

A systematic review is a highly structured review of existing literature on a specific subject or group of subjects with the goal of distilling a targeted subset of knowledge from the global repository of available information.

Systematic reviews are conducted by having subject matter experts review identified pieces of literature and complete a series of forms designed to first screen out irrelevant documents and later to extract core data from the forms that pass the screening process. The protocols for conducting systematic reviews need to be rigorous and well defined in order for the results of the review to be valid.

However, the current, largely manual methods by which these protocols are carried out may introduce errors.

A typical systematic review surveys all the previous work in a field of medicine to determine if a particular scientific question has been answered. Such a question might be: does drug A significantly shorten the duration of disease B? The cost of a review is virtually always significantly less than the cost of a scientific study to answer the question, which is why reviews are carried out routinely before any study is contemplated.

Obviously an error in a review may have extremely serious consequences. Believing that the question is not answered wastes the cost of the study that follows, which as mentioned is virtually always significantly greater than the cost of the review. Believing that one has the answer to a question which has not been answered can have even worse consequences. A wrong answer may lead not only to misdiagnosis or mistreatment, but more subtly it has the potential to misdirect future research.

Though conducting systematic reviews is process intensive with a good deal of data management overhead, most systematic reviews today involve very little automation. Reviews are typically done by distributing paper copies of the forms along with printouts of article abstracts to reviewers who then complete the paper forms and send them back. Once completed forms have been received, a data entry person typically transcribes the responses into a database, for example an Excel spreadsheet or a customized Access database. Once the data is in the database, it is processed to determine which articles are excluded, what full articles will need to be ordered and to determine if any conflicts exist between answers provided by different reviewers for different articles.

Once the data is processed for one level of the review, a new, culled, article list is generated and this, along with the forms and, where applicable, complete copies of the articles for the next level are sent to the reviewers. This sequence repeats itself until the review is complete.

The issues with systematic reviews as they are conducted today are numerous. At the outset, review forms must be designed according to the desired protocol, printed and physically delivered to reviewers along with the relevant group of articles or documents to be reviewed. Completed forms must then be delivered back to the coordinating site. The physical transfer of paperwork can consume a lot of time, particularly if reviews are geographically dispersed, and of course the cost of providing multiple paper copies, collating review sets of documents, and having them delivered to the reviewers is a significant aspect of the overall provisioning cost.

The process of transcribing data from paper forms into electronic form is also time consuming and may introduce errors. Manually analyzing data to determine article eligibility has similar problems.

In view of the foregoing, it would be desirable to provide a technique for systematic review which overcomes the above-described inadequacies and shortcomings by providing a system which enhances efficiencies of document handling, while reducing the opportunities for error in the review process.

### SUMMARY OF THE INVENTION

An object of the present invention is to provide an improved systematic review system.

According to an aspect of the present invention there is provided a computer mediated system for systematic document review of a defined set of documents on a display device. The system has means for establishing a set of review levels and a set of criteria for a document under review to attain a particular level of the set of review levels, and further means for establishing a set of electronic review forms. Further, the system has means for providing to the display device at least one of the set of the set of electronic review forms and means for entering and storing data entered on the electronic review forms. As well, the system has means for determining the level attained by the document from the defined set of documents by comparing the data captured in conjunction with the set of criteria; and means for reporting.

Advantages of the present invention include reducing the costs associated with the design of systematic review studies, and the questionnaire forms to be used by the reviewers. Further cost savings are accomplished via electronic document publication, dissemination, and collection. The invention also reduces the errors and time delays inherent to manual results.

Advantageously, the computer mediated system may be operated over a network. Conveniently, the network may be the Internet. The advantages of using a network stem from the benefits of being able to draw upon geographically separated experts.

Conveniently, the means for establishing a set of review levels and a set of criteria for a document under review may include a levels setting module running on a network selected from the group consisting of client-server networks, peer-to-peer networks and networks having disconnected synchronization means. Also conveniently, the means for establishing electronic review forms may include a form editor module running on a network selected from the group consisting of client-server networks, peer-to-peer networks and networks having disconnected synchronization means.

Advantageously, the system may also include means for providing to a reviewer at least one of the set of the set of electronic review forms and an electronic copy of a document from the defined set of documents. Conveniently, this means may include a document review module running on a network selected from the group consisting of client-server networks, peer-to-peer networks and networks having disconnected synchronization means. The provision of an electronic copy of the document obviates the need to copy and disseminate paper copies of the articles to the reviewers, saving time and expense. Further, the document review module may advantageously further include a side-by-side display capability for presenting the electronic review form and at least a portion of the electronic document under review adjacent each other upon the display device. The side-by-side capability simplifies access to the electronic review form while reviewing the document, and further keeps the form criteria visible as a context for the review.

Advantageously, the computer mediated system may include a document display filter means for selecting a specific document from the defined set of documents. Conveniently, this means may include a document display filter module running on a client server network. Advantages of a display filter include allowing a reviewer to filter the document set for documents yet to be reviewed.

Advantageously, the means for entering and storing data entered on the electronic review forms may have a data entry device coordinated with the display device, and memory means associated with a network selected from the group consisting of client-server networks, peer-to-peer networks and networks having disconnected synchronization means.

Beneficially, the means for determining the level attained by the document from the defined set of documents by comparing the data captured in conjunction with the set of criteria may have a document progression module running on a network selected from the group consisting of client-server networks, peer-to-peer networks and networks having disconnected synchronization means.

Advantageously, the computer mediated system may further have a document reprocessing means having means for changing the set of review levels and the set of criteria for a document under review to attain a particular level of the set of review levels and means for re-determining the level attained by the document from the defined set of documents by comparing the data captured in conjunction with a changed set of criteria. This would allow study administrators to make changes in the forms and level settings and to propagate these changes across the previously reviewed documents. This minimizes the needs associated with the reviewers reentering review data and can result in savings in both time and errors. Conveniently, the document reprocessing means may include a document reprocessing module running on a network selected from the group consisting of client-server networks, peer-to-peer networks and networks having disconnected synchronization means.

Advantageously, the means for reporting may include a reporting module running on a network selected from the group consisting of client-server networks, peer-to-peer networks and networks having disconnected synchronization means.

Also advantageously, the reporting module may include at least one of a document progress tracking module reporting on the review level attained by a specific document, a document presence module reporting on the availability of a specific document in the defined set of documents, an exclusion reporting module reporting the set of documents from the defined set of documents which have had data entered which satisfy criteria for exclusion, and a conflict reporting module reporting the set of documents from the defined set of documents which have had data entered which satisfy criteria for conflict. The various reporting modules provide the study administrator the means to generate a detailed view of the status of the review study as a whole, and of particular document subsets generated by the study to a particular point in time. The various reporting modules also facilitate the generation of reports in near real time, an advantage over manual systems requiring considerable collation of documents.

According to another aspect of the invention there is provided a method for conducting a review of a defined document set, the method having the steps of first, defining a review schema, then incorporating the review schema into an electronic review form. Subsequently, collecting data entered into the electronic review form; and then reporting the collected data.

Advantageously, the defining step may include defining a series of at least two review levels, wherein each review level has at least one associated electronic review form, and wherein the series is sequential.

Advantageously, each of the review levels comprises one of the group consisting of a screening level and an extraction level. Each screening level specifies criteria which when satisfied identifies a particular document under review as being excludable. Each extraction level specifies criteria which identifies specific data to be extracted from a particular document under review.

Beneficially, the incorporating step using a form creation module.

Advantageously, the method further includes the step of providing the electronic review form to a terminal across a network. Further, the method may include the step of providing an electronic copy of a document to be reviewed. Conveniently, this electronic copy of a document to be reviewed may be provided to a terminal across a network.

Advantageously, the method further includes a step of providing a split screen view of the electronic review form and the electronic copy of a document to be reviewed. Conveniently, the split screen view is provided to a terminal across a network.

Advantageously, the collecting step is done across a network. Conveniently, the collecting step may be followed by storing the collected data into at least one data table. This storing step may be followed by the step of processing the data stored in the at least one data table according to the review schema.

Advantageously, the storing step may be followed by the steps of reconfiguring the review schema; and processing the data stored in the at least one data table according to the reconfigured review schema.

Advantageously, the storing step may be followed by the step of promoting a reviewed document to a next level according to the stored data and the review schema. The promoting step may occur under a liberal screening level schema, or alternatively, the promoting step may occur under a strict screening level schema. Further, the promoting step may also occur under a data extraction level schema.

Advantageously, the storing step may be followed by the step of excluding a reviewed document from promotion to a next level according to the stored data and the review schema. Also advantageously, the storing step may be followed by the step of flagging a reviewed document as in a state of review conflict according to the stored data and the review schema.

Conveniently, the reporting step provides output data relevant to the documents excluded according to the collected data and the review schema. As well, conveniently, the reporting step provides output data relevant to the documents rendered in a state of conflict according to the collected data and the review schema. Further, conveniently, the reporting step provides output data relevant to the documents promoted according to the collected data and the review schema

According to another aspect of the invention there is provided an article of manufacture for conducting a review of a defined document set, the article of manufacture having at least one processor readable carrier and instructions carried on the at least one carrier; wherein the instructions are configured to be readable from the at least one carrier by at least one processor and thereby cause the at least one processor to operate so as to perform the acts of first, defining a review schema, then incorporating the review schema into an electronic review form. Subsequently, collecting data entered into the electronic review form; and then reporting the collected data.

The present invention will now be described in more detail with reference to exemplary embodiments thereof as shown in the appended drawings. While the present invention is described below with reference to the preferred embodiments, it should be understood that the present invention is not limited thereto. Those of ordinary skill in the art having access to the teachings herein will recognize additional implementations, modifications, and embodiments which are within the scope of the present invention as disclosed and claimed herein.

### BRIEF DESCRIPTION OF THE DRAWINGS

The invention will be further understood from the following detailed description of embodiments of the invention and accompanying drawings in which:

FIG. 1 is a diagram of the architecture and data flows of a systematic review system according to an embodiment of the invention.

FIG. 2 is a screen shot of level definition settings according to an embodiment of the invention.

FIG. 3 is a program structure diagram of the decision branches for a Liberal screening methodology according to an embodiment of the invention.

FIG. 4 is a program structure diagram of the decision branches for a Strict screening methodology according to an embodiment of the invention.

FIG. 5 is a program structure diagram of the decision branches for a data extraction methodology according to an embodiment of the invention.

FIG. 6 is a screen shot produced by an obtained articles tracking module according to an embodiment of the invention.

FIG. 7 is a screen shot produced by a field mapping tool aspect of the obtained articles tracking module according to an embodiment of the invention.

FIG. 8 is a screen shot produced by side-by-side full article reviewing module according to an embodiment of the invention.

FIG. 9 is a screen shot produced by an article display filter module according to an embodiment of the invention.

FIG. 10 is a screen shot produced by an article progress tracking module according to an embodiment of the invention.

FIG. 11 is a screen shot produced by an exclusion reporting module according to an embodiment of the invention.

FIG. 12 is a screen shot produced by a first type of report generated by an exclusion reporting module according to an embodiment of the invention.

FIG. 13 is a screen shot produced by an conflict reporting module according to an embodiment of the invention.

### DETAILED DESCRIPTION

The present invention will now be described in more detail with reference to exemplary embodiments thereof as shown in the appended drawings. While the present invention is described below including preferred embodiments, it should be understood that the present invention is not limited thereto. Those of ordinary skill in the art having access to the teachings herein will recognize additional implementations, modifications, and embodiments which are within the scope of the present invention as disclosed and claimed herein. In the figures, like elements are given like reference numbers. In the following discussion, both the terms articles and documents may be used interchangeably.

The systematic review system (SRS) includes a number of concepts that are new to the field of systematic reviews. These concepts and methodologies were made possible by the new capabilities brought by SRS. Two key concepts are levels and forms.

ESR Levels

During a the course of a review an article will vetted by reviewers against a number of study instruments to first validate its appropriateness for the review and then to extract the required data from it. A typical systematic review may contain the following study instruments:

Initial Screening Form: Used to quickly determine if an article may be appropriate for the study. During the initial screening stage reviewers often complete the form using only article abstracts and bibliographical information. A typical screening question might be “Is this study an RCT?”

Strict Screening Form: A second level of screening where, typically, reviewers are given full copies of articles when completing screening forms to determine if particular articles should remain in the study.

Data Abstraction Forms: These study instruments are used to extract information from articles that have made it past screening. This is the information that will be used in the final analysis for the review. Typical data abstraction questions are “number of patients in the study?”, “what was the outcome of the study?”, “what type of allocation concealment was used?”, etc.

In most cases, articles progress through the review in a linear fashion starting with the screening form and ending with data extraction. Because of this, each form in an electronic systematic review (ESR) is referred to as having an associated level. The level of a form defines its position in the overall review process. While there are is no absolute rule as to the number of levels that should be used in a review, most groups use between one and two screening levels and between two and four data extraction levels.

A review may have as many or as few levels as required and they may be arrayed in whatever order is appropriate for the study.

Promotion, Exclusion and Conflict

The act moving an article from one level to the next, based on reviewer answers to questions in a form, is called promotion. The act of removing an article from the study due to reviewer answers to a screening form is called exclusion.

ESR screening levels associate inclusion (or promotion) and exclusion criteria with each possible answer in a form. For example, a screening question may be defined as follows:

### EXAMPLE 1

### A typical Screening Question with Response Consequences

Was this study an RCT?
Yes (Inclusion)
No (Exclusion)
Can't Tell (Inclusion or Neutral)

In the above question, if reviewers selected the “Yes” response then, based on this question, the article should remain in the study. If they unanimously answered “No” then the article should be removed from the study. If reviewers indicated can't tell, the action taken will depend on the level type and configuration (see ESR Level Types below).

ESR Level Types

ESR levels contain the study instruments used in a review and there is one form per level. Levels also embody the algorithms for determining how to process articles based on reviewer input. These algorithms are applied to articles to either promote or exclude them based on reviewer response to a form.

ESRs define three basic level types:

Liberal Screening: Liberal screening is typically the first level of screening. It is used to quickly excluded articles that are obviously not applicable to the particular review. Reviewers in liberal screening have access only to citations an abstracts, and not to full copies of articles.

In this level type, articles are promoted if one of two criteria are met:
At least one reviewer responded with Inclusion or Neutral responses to every question in a single form
The same Exclusion response was not selected by all reviewers

Note that the second point is an optional ESR behaviour. The premise behind the behaviour is that if more that one reviewer cannot agree on reasons for exclusion then there is probably not enough information available for the reviewers to make an accurate decision. The article is therefore promoted to the next screening level where the full article may be available to aid in the screening process.

Articles will be excluded from a study during liberal screening only if all reviewers agree on at least one exclusion response. For example, if a liberal screening form contains ten questions and all reviewers answer “No” to question 8, and this answer has an exclusion consequence, then the article will be removed from the study.

Strict Screening: Strict screening typically follows a liberal screening level. In strict screening, reviewers typically have access to the full article being screened.

In this level type, articles are promoted if the following criteria are met:
No reviewers select exclusion or neutral responses for any of the questions in the form

Similarly, articles may only be excluded from this type of level if all reviewers select at least one matching exclusion response from the form.

If none of the above criteria are met, the article will go into a state of conflict. The article will remain at its current level in a conflict state until all reviewers either select inclusion responses for all questions or they agree on at least one exclusion response.

Articles for which unanimous Neutral (or can't tell) responses have been submitted will be placed into conflict even if all reviewer responses match. The reason for this is that Strict screening is typically the final screening level before data extraction. Only articles that have been vetted and determined to belong in the study should make it to the data abstraction phase. If this were not the case then data from questionable articles would be added to the result set used later for meta-analysis.

Data Extraction: Since data extraction is used only to draw data from vetted articles, this level type has no inclusion/exclusion capability. Articles are promoted from a data extraction level as soon as the required number of reviewers have submitted their responses.

Data Tables

A number of tables are stored in a relational database in order to maintain the definitions for the design of the systematic review and the forms and levels associated with a particular review.

Articles Table

The Articles table is used to store the bibliographical information about each article in an SRS project. The table also stores the current status as well as a binary copy of a file containing the article.

In an embodiment of the invention the Articles table is of the form:

| | | | | | | | |
|---|---|---|---|---|---|---|---|
| ReferenceID | Field1 | Field2 | Field3 | Status | CurrentLevel | Upload | OrderStatus |

where:
ReferenceID is the unique identifier for the article.
Field 1, Field2, and Field3 store textual information about the article. These fields may contain whatever the end user requires and if required the number of these fields may be increased.
Status holds the current status of the article: Included, Excluded or Conflict
CurrentLevel stores the form level that the article is currently at
Upload stores a binary copy of the complete article. This may be in any convenient format e.g. PDF ™, MS ™ Word, text, AVI, MP-3, etc.
OrderStatus tracks the whether or not the article has been ordered, procured or is not available for procurement

Custom Fields Table

This table stores the fields used to store information in the Articles table. Users may add and remove fields dynamically. The visible name of for each field is also stored in this table.

| | | |
|---|---|---|
| TagName | VisibleName | Order |

TagName stores the field name used by the database for this field
VisibleName stores the name of this field that is used when displaying it in SRS
Order defines the order in which the fields should be read or writing in importing or exporting data. This is used by the import and export routines

Reviewer Link Table

This table maps the project participants to the SR levels at which they will be reviewing.

| | |
|---|---|
| ReviewerID | Level |

ReviewerID is the unique identifier for the reviewer
Level indicates which Level or form the reviewer is reviewing

Question Table

This table contains all questions for all forms in the project

| | | | | | |
|---|---|---|---|---|---|
| Question ID | Level | Type | Order | Text | Option |

QuestionID is the unique identifier for the question
Level indicates which Level or form the question belongs to
Type indicates the question type (i.e. multiple choice, checkbox, text, etc)
Order indicates the order in which the question should be displayed in the form
Text is the HTML text for the question
Option is a Boolean defining whether or not the question is optional

Answer Table

This table contains all answers for all forms in the project

| | | | | |
|---|---|---|---|---|
| AnswerID | QuestionID | Text | HasText | Consequences |

AnswerID is the unique identifier for the answer
QuestionID identifies the question to which this answer is associated
Text contains the HTML text of the answer
HasText indicates whether or not to place a free-form text entry box next to this answer (note: this only applies to multiple choice and checkbox answers
Consequence indicates whether this answer constitutes an Include, Exclude or Neutral criteria (note: this only has effect in Liberal and Strict screening levels)

ResponseLink Table

This table contains all users responses submitted through the level

| | | | | |
|---|---|---|---|---|
| UserID | ReferenceID | AnswerID | Text | TimeStamp |

UserID contains the ID of the reviewers who submitted the response
ReferenceID is the ID of the article that was reviewed
AnswerID contains the ID of the answer selected
Text stores any free-form text submitted with the response
Timestamp contains the time and data that the answer was submitted on

ProjectData Table

This table contains settings for the project

| | |
|---|---|
| FieldName | Value |

FieldName contains the name of the setting being stored
Value contains the value of the setting

General Properties Stored in the ProjectData Table

This table stores the settings for a particular defined project and has two fields, a name field and a value field, for each attribute stored in the table.

| Attribute | Field Name | Value |
|---|---|---|
| Level Type | Level<n>Type | Liberal, Strict, or |
| | | DataExtraction |
| Promote Conflicted | PromoteConflicted<n> | True or False |
| Articles | | |
| Reviewers needed to | RequiredReviewers<n> | Number of |
| process article | | reviewers required |
| Par Reviewer | ParReviewer<n> | Reviewer id |
| Partition the level | Partition<n> | True or False |
| Exclusion Granularity | ExclusionGranularity <n> | Question or Form |
| Allow Article Flagging | AllowFlagging<n> | True or False |
| Show Abstracts and | ShowAbstracts<n> | True or False |
| Keywords | | |
| Bibliographic Style | Style<n> | Style Name |

where <n> represents the numeric value of the form level being defined.

Reviewers Table

The reviewers assigned to each level are stored in a single table for an SRS project. The table has four fields as follows:

| | | | |
|---|---|---|---|
| Reviewer ID | Level | StartingRefid | StopRefid |

ReviewerID is the unique identifier for the reviewer (as per Reviewer Link Table)
Level indicates which Level or form the reviewer is reviewing(as per Reviewer Link Table)
StartingRefid is the ReferenceID of the first article assigned to a specific reviewer at a specific level should the level be partitioned
StopRefid is the ReferenceID of the last article assigned to a specific reviewer at a specific level should the level be partitioned.

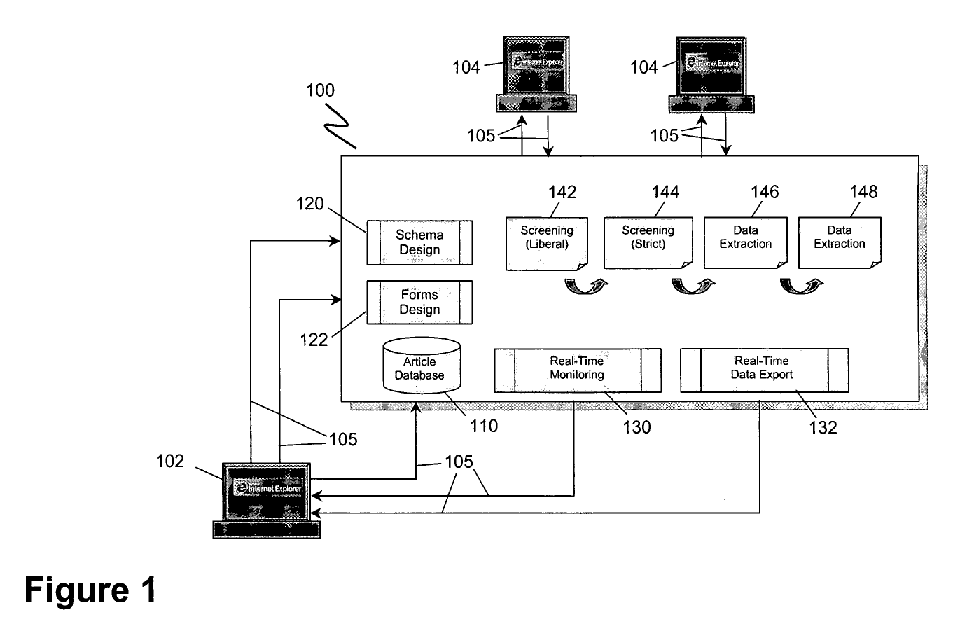

Referring to FIG. 1 there may be seen a diagram of the architecture and data flows of a systematic review system (SRS) 100 according to an embodiment of the invention. SRS 100 provides a complete and comprehensive environment that allows groups to collaborate in the conduct of systematic reviews using a network, for example the Internet. The system allows study coordinators to author electronic versions of the forms used in the screening and data extraction process. SRS also provides for the study logic to be embedded within the electronic forms such that, once a form has been completed for a specific piece of literature, the system can determine what the next step will be for that piece of literature within the review (e.g. the article will be screened out of the review or the article will be analyzed for content). Under some embodiments, the forms are made available to reviewers via a secure interfaces. As well, the system has provisions for controlling what forms and articles are available to each reviewer based on protocols set by a study coordinator.

SRS 100 is typically comprised of one or more reviewer terminals 104 coupled to one or more information processors 130 though data communication network links 106. As used herein, the term “reviewer” refers to a person charged with the task of reviewing a specific article, document or piece of literature. The document could be a scientific article, for example in the medical field, as is presently done for systematic document reviews. Alternatively, the documents could be related to policy and project descriptions for Internal Review Boards and Ethics Committees. Yet further applications, by way of example, include:
common drug review submission evaluations;
analysis of competing products in a marketplace for generation of feature grids; and
case analysis study in legal projects, where junior associates could review precedent cases based upon form criteria defined by a more senior firm member, so as to generate a distilled, searchable dataset.

Also connected via a network to SRS 100 is the study administrator terminal 102. As used herein, the term “study administrator” refers to a person charged with the task of defining and managing a particular review project. Clearly this “person” may in reality comprise different persons at different points in the project's lifecycle. Also, it is anticipated that there may be multiple study administrators corresponding to different projects wherein one study administrator may be defining a study project and a different study administrator may be managing another review project by monitoring the project status or exporting data from the project.

It should be noted that the network through which user terminal 104 and study administrator terminal 102 is shown as a schematic set of links 105 for the convenience of aiding explanation of the present invention. In practice links 105 can be the Internet or other public or private network comprised of multiple communication networks, coupled together by network switches or other communication elements. The network could be of the form of client-server networks, peer-to-peer networks and networks having disconnected synchronization means. Examples of the latter include networks which allow for apparatus which connect to the network for synchronization purposes and can then operate in disconnected mode. For example PalmPilot(TM) using a hotsync facility, or portable computers which connect and synchronize to a network via a docking station but that can then be operated disconnected.

User terminals 104 and study administrator terminal 102 are comprised of any computer platform capable of running an Internet web browser or similar graphical user interface software. Examples of suitable web browsers include Microsoft™'s Internet Explorer™ and Netscape™'s Communicator™. The computer platform for terminals 102 and 104 can vary depending upon the needs of its particular user and can range from a desktop, laptop, or handheld personal computer or personal digital assistant to a UNIX-based workstation or mainframe computer.

User terminals 104 and study administrator terminal 102 preferably communicate with SRS 100 using the Transmission Control Protocol/Internet Protocol (TCP/IP) upon which particular sets of that protocol can be used to facilitate communication. Examples include Hypertext Transfer Protocol (HTTP), data carrying Hypertext Mark-Up Language (HTML) web pages, Java™ and Active-X™ applets and File Transfer Protocol (FTP). User terminals 104 and study administrator terminal 102 are capable of generating and retrieving the HTML pages and applets and displaying the appropriate information on the associated displays of the terminals.

It should also be noted that references to “selecting” or “choosing” refer to the selection by the user of a terminal of an object presented on the display of a terminal. Also, the term “link” is used to mean a reference to different display data such as an HTML reference to another web page.

Data connections 105 between user terminals 104 and SRS 100 can be any known arrangement for accessing a data communication network, such as dial-up Serial Line Interface Protocol/Point-to-Point Protocol (SLIP/PPP), Integrated Services Digital Network (ISDN), dedicated leased line service, broadband (e.g. cable) access, Digital Subscriber Line (DSL), Asynchronous Transfer Mode (ATM), Frame Relay, or other known access technique (e.g. radiofrequency (RF) links). Study Administrator terminal 102 is coupled to SRS 100 in a like fashion.

Within SRS 100 are located at least one information processor (not shown) used to execute software code in order to control the operation of SRS 100. Associated with the information processor are the usual ancillary devices known to those skilled in the art as necessary to the operation of an information processor, including read only memory, random access memory, network interfaces to transmit and receive data to and from other computer devices across the network, and storage devices for storing program code and instructions, databases, and application data such as hard drives, floppy disk drives, tape drives, CD-ROM and DVD-ROM drives.

The various components of the information processor of SRS 100 need not be physically contained within the same chassis or co-located in a single location. For example, the storage device may be located at a site remote from the other elements of the information processor and may be connected to the information processor across a data communication network via the network interface.

The nature of the invention is such that one skilled in the art of writing computer executable code i.e. software, would be able to implement the described functions using one or more popular computer programming languages such as C++, Visual Basic, Java™, or HTML.

User terminals 104 and study administrator terminal 102 are preferably equipped with web browser software which supports “frames”, i.e. the capability to divide the display into multiple display sections so as to allow the user to view different types of data in each of the different sub-areas. For example, user terminal 104 may display an article area showing an image of a document to be reviewed, and can simultaneously display a form area containing a list of questions with answer options to be selected, or text boxes within which specific entries may be made.

Referring again to FIG. 1, there may be seen several subsystems representing the broad functions of SRS 100 including forms design subsystem 122, project schema design subsystem 120, article database 110, real-time monitoring subsystem 130, and real-time data export subsystem 132. The project schema design subsystem 120 and forms design subsystem 122 contain software modules typically used by study administrator's to set up a particular review project. The software modules operate by loading particular values and settings into the data tables described previously. Article database 110 contains copies of the articles which are to be reviewed during a review project. Real-time monitoring subsystem 130 and real-time data export subsystems 132 contain software modules typically used by study administrator's to monitor and produce reports regarding a particular review project. The software modules operate by extracting particular values and settings from the data tables described previously.

Also visible within SRS 100 is an example data flow 142, 144, 146 and 148 representative of levels established for a particular review project. In the example depicted in FIG. 1, each of the data flow elements represents a particular level in a review. In this exemplary data flow there is a screening level (liberal) 142, a screening level (strict) 144, and two successive data extraction levels 146 and 148. The arrows connecting the levels are representative of the flow of articles through the screening levels.

The operation of the software modules along with accompanying exemplar screen displays will now be described.

Level Settings Module

The definition and behaviour of ESR levels are is encapsulated and embedded in the level settings module. The module embodies ERS level methodologies and allows study administrators to precisely control the behaviour of each level.

The key aspects of the level settings module are as follows.
Setting the screening algorithm (i.e. Liberal, Strict or Data Extraction)
Setting the total number of reviewers at a level
Setting the total number of reviewers required to review each citation at the level
Setting different subsets of articles to be reviewed by different reviewers. The system allows complete control over which articles and levels each particular reviewer will participate in.
Setting whether a PAR reviewer will be used in the project. SRS provides for the use of a PAR reviewer. This is a person who's responses are not stored in the overall response table for the project (i.e. their answers are not used as part of the study results). The purpose of a PAR reviewer is to provide an answer set to which the responses of all other reviewers can be compared. This is typically used at the beginning of a study to “calibrate” reviewers; to get reviewers responding to the form questions in a consistent manner
Setting the Exclusion Granularity. Exclusion granularity determines if responses to an entire form or to individual question are used when determining whether or not an article should be excluded. As an example, posit that Reviewer A says “yes” to Question 1 in a form and “no” to Question 2. Then “Yes” is an inclusion response in Question 1, and “No” is an exclusion response in Question 2. Further posit that Reviewer B responds “no” to Question 1 and “yes” to Question 2 in respect to the same article. The Exclusion Granularity setting will then determine the disposition of the article. If exclusion granularity is set to “Form” then ESR methodology dictates that exclusion is based on the Gestalt result for each form. Since each form contains at least one exclusion, the article will be excluded. If exclusion granularity is set to “Question”, then exclusion answers must match, so the article, in this case, will not be excluded. It will instead go into a state of conflict.
Setting the type of screening: Liberal or Strict. SRS provides for promoting conflicted articles in Liberal Screening. When this setting is configured, articles with conflicting reviewer responses will be promoted as long as no exclusion responses match. The concept behind this behavior is that if two or more reviewers cannot agree on a reason for exclusion then they may not have enough information to accurately exclude an article and the article should be promoted to a level where more information, for example the full article, is available. On the other hand, if Strict Screening is set, then a single exclusion will exclude the article.
Setting the threshold of screening. SRS provides for accelerated screening at Liberal Screening levels. The premise is that, at Liberal Screening, an article is promoted so long as at least one reviewer does not exclude the article. With Accelerated Screening activated then as soon as one reviewer reviews an article and does not excluded it, the article is promoted. This prevents other reviewers from reviewing the article at this level and thus saves potentially unnecessary effort.
Setting the format of the article information that is available to reviewers on the review forms. Study administrators can set the bibliographical format in which the citation information will be displayed as well as setting whether or not to show the article abstracts and keywords on the form
Selecting the individual reviewers who will be reviewing at this level.

All of the values set in the level settings module can be change “on the fly” during the course of a review, allowing a study administrator to refine the project schema as necessary. The level settings module stores the settings in the General Properties Table as described previously for a given SRS project.

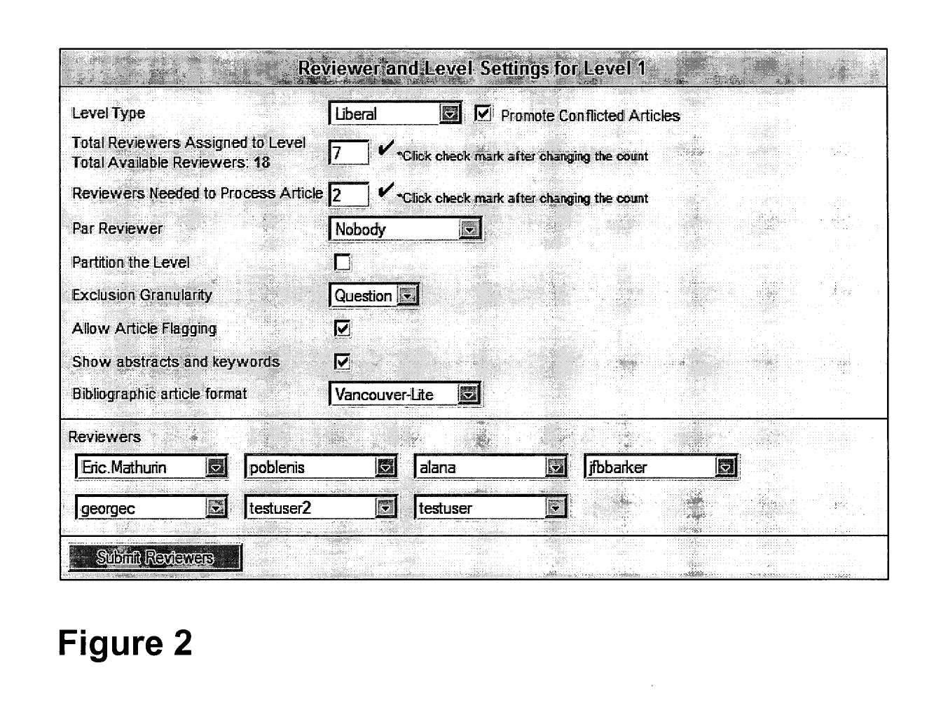

An example of a screen display providing a graphical user interface for this module may been seen in FIG. 2. The study administrator selects the appropriate settings in the text and check boxes, and in the pull down menus portions. The user interface of FIG. 2 provides a convenient way to both establish and review the settings for a particular level of a given SRS project.

Automated Article Progression Module

In a systematic review, literature that has been identified for review (i.e. articles) must pass through various levels of screening (forms) before they are either excluded (at screening levels) from the study due to lack of suitability or are analyzed in depth for relevant content (at extraction levels).

The automated article progression module is a software module within SRS that controls the flow of articles between the various levels of a systematic review based on the following criteria:
type of level or form (liberal, strict, data extraction);
specified consequences of answers selected in the form;
the number of reviewers who will be participating in a given level;
exactly who will be participating as a reviewer in the level (for example, a review may have 8 participants with 5 junior members participating in the screening levels and 3 subject matter experts doing data extraction); and
the number of reviewers required to review each article at that level before an promotion/exclusion decision can be made.

The above criteria are set by designated users, typically study administrators, as the study is configured. The module uses these criteria when processing reviewer responses to set the level and state of an article.

By way of example, if a form is completed for an article at a Liberal screening level, this module will review the users responses and, based on the defined consequences of the answers to each question (defined by the study administrator when authoring the form) will determine if this article should be excluded from the study or if it should progress to the next level of the study. The module will also check to see if enough reviewers have completed the form for this article for an exclude/progress decision to be made (the study coordinator determines the number of reviewers required to review each article at each study level and sets this as part of the study protocol).

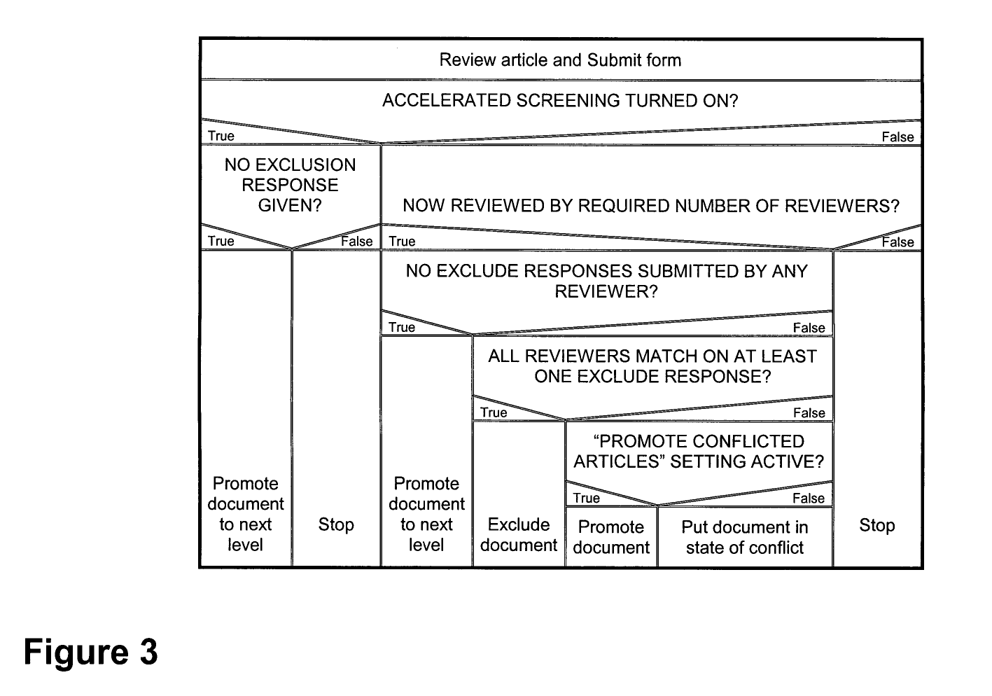

The decision branches of the algorithms used by the automated article progression module are illustrated in the program structure diagrams of FIGS. 3, 4, and 5. A more full description of the steps is described below.

FIG. 3 depicts the decision branches for Liberal screening. For a Liberal screening setting the automated algorithm progression module does the following upon submission of a form by a reviewer:

1) The ProjectData table is checked to see if Accelerated Screening is enabled
If Yes:
a) the form responses are checked to see if any exclusion responses are submitted. Inclusion, Exclusion and Neutral traits of responses are stored with each responses in the Answers table
b) If none of the responses submitted are exclusion responses then promote the article. If an exclusion response has been submitted then do nothing.

2) The ProjectData table is checked for the number of reviewers required for this level

3) The Response table is checked to see how many reviewers have submitted forms at this level

4) If the number of reviewers who have submitted responses is not greater than or equal to the number of required reviewers then do nothing

5) If the number of reviewers who have submitted responses is greater than or equal to the number of required reviewers then continue processing

6) If no exclusion responses were submitted by any reviewer then promote the article and stop processing

7) If exclusion responses have been submitted and all reviewers match on at least one exclusion response then mark the article as excluded by setting its status flag to Excluded

8) If exclusion responses have been submitted and all reviewers no not match on at least one exclusion response then check the ProjectData table to see if the PromoteConflictedArticles flag is set for this level

9) If PromoteConflictedArticles is true for this level then promote the article by incrementing the article's CurrentLevel field by 1

10) If PromoteConflictedArticles is not true for this level then put the article in a state of conflict by changing its status field to Conflict

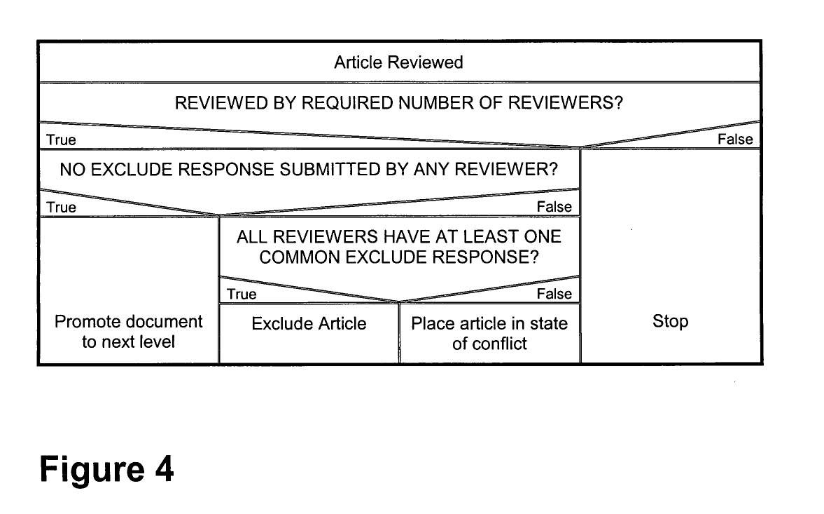

FIG. 4 depicts the decision branches for Strict screening. For a Strict screening setting the automated algorithm progression module does the following upon submission of a form by a reviewer:

1) The ProjectData table is checked for the number of reviewers required for this level.

2) The Response table is checked to see how many reviewers have submitted forms at this level.

3) If the number of reviewers who have submitted responses is not greater than or equal to the number of required reviewers then do nothing.

4) If the number of reviewers who have submitted responses is greater than or equal to the number of required reviewers then continue processing.

5) If no exclusion responses were submitted by any reviewer then promote the article by incrementing its CurrentLevel field and stop processing.

6) If exclusion responses have been submitted and all reviewers match on at least one exclusion response then mark the article as excluded by setting its status flag to Excluded.

7) If exclusion responses have been submitted and all reviewers no not match on at least one exclusion response then put the article in a state of conflict by changing its status field to Conflict.

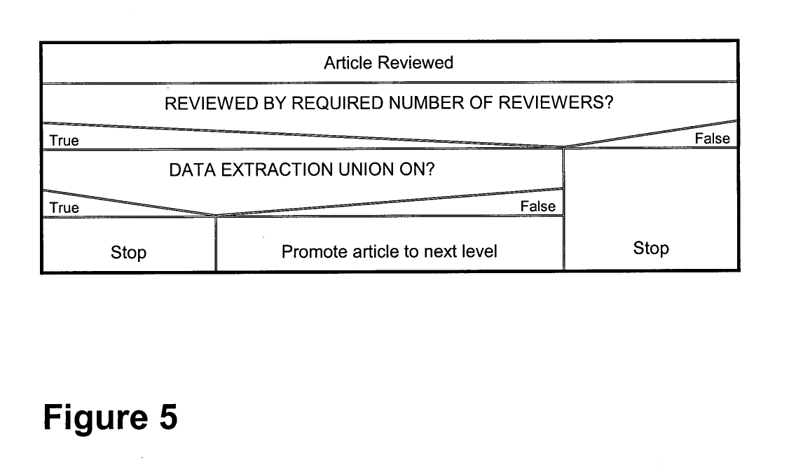

FIG. 5 depicts the decision branches for data extraction screening. For a data extract level setting the automated algorithm progression module does the following upon submission of a form by a reviewer:

1) The ProjectData table is checked for the number of reviewers required for this level.

2) The Response table is checked to see how many reviewers have submitted forms at this level.

3) If the number of reviewers who have submitted responses is not greater than or equal to the number of required reviewers then do nothing.

4) If the number of reviewers who have submitted responses is greater than or equal to the number of required reviewers then continue processing.

5) If DataExtractionUnion is set to True in the ProjectData field then stop processing.

6) If DataExtractionUnion is not set to True then promote the article by incrementing the articles CurrentLevel field by one.

The advantages of this methodology are realized a number of ways:

1) Using accelerated screening can reduce the number of reviewers who screen an article at Liberal screening from n to 1, where n is the number of reviewers set to participate in the screening level. This can reduce the total screening forms completed for the project in liberal screening from n x m to m, where m is the number of articles to be reviewed at liberal screening. This represents a significant potential time and cost savings.

2) Automated screening reduces time by insuring that only the required number of reviewers review each article. This also provides real-time load balancing by allowing reviewers to review as many articles as they are capable of rather that pre-allocating specific subsets of articles to specific reviewers.

3) Automated screening and processing reduces errors by eliminating manual data transcription, collation and progression rule application.

Obtained Article Tracking Module

Because of the costs of purchasing reference material, and because it is inefficient to read every article identified as a candidate for a systematic review, it is typical practice to review only article titles and abstracts during the initial screening levels of a systematic review. Once articles progress past a certain screening level without being excluded from a study, study administrators will order the complete text for the article so that the data extraction forms can be completed.

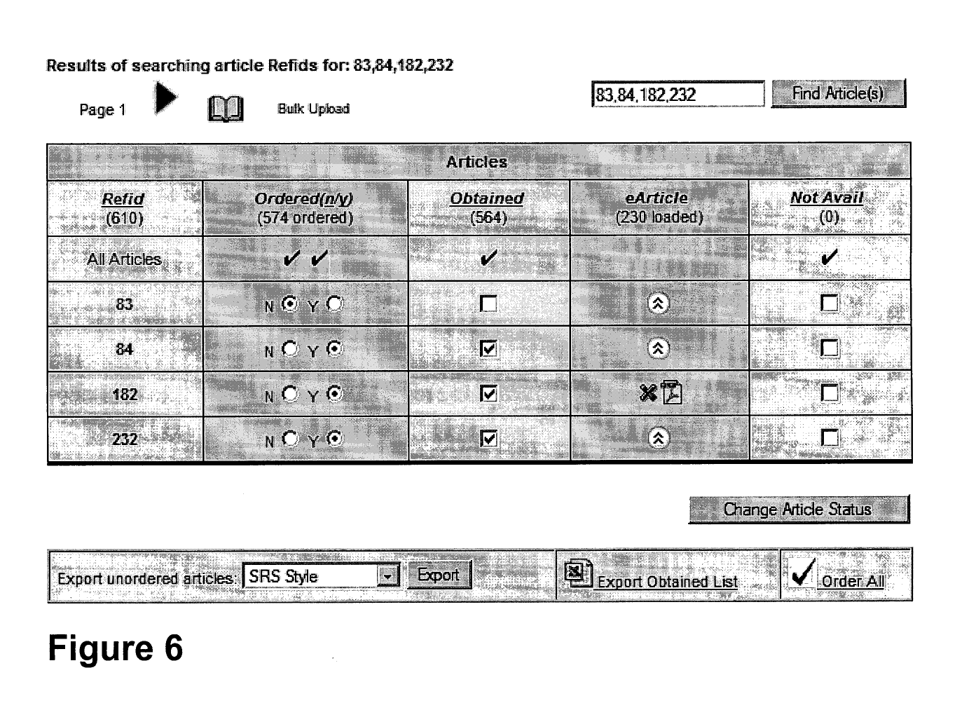

The obtained article tracking module displays information on which articles have progressed to a user specified level of a review. The module then tracks the process of ordering and obtaining articles from publishers. An example of a screen display providing a graphical user interface for this module may been seen in FIG. 6.

Information on what articles are eligible to be obtained, which articles have been ordered, which have been successfully obtained, which can not be obtained and those which have been obtained electronically and uploaded into the system can be viewed and set by designated users. Order status set in this module is also conveyed back to reviewers to let them know what articles are available for them to read. This is done by displaying a small image next to the citation's bibliographical information on the review pages and form pages. Different images are used to distinguish between articles that been obtained and which have actually been uploaded into the systems. Clicking on the image that indicates that an article has been uploaded will cause the article to be downloaded and displayed on the reviewer's computer.

Full electronic copies of articles may be uploaded into central database by clicking on an upload image next to the reference identifier of the article that is to be uploaded. Doing this presents the user with an screen that allows them to browse for the desired file and upload it. Uploaded articles are immediately available to reviewers for download and viewing.

Some stand-alone reference management tools provide tools for tracking the order status of articles. This typically takes the form of a dedicated field in the tool's citation database. The Obtained Article Tracking module provides utility to synchronize with the order status field so that reference data exported from SRS will contain any ordering information added or modified within an SRS based project. Similarly, ordering status that has been set from with third party reference management tools can be reflected in the U1 of the Obtained Article Tracking tool. This is accomplished by allowing users to map article ordering status' within SRS to the specific field and status strings used.

Automated article tracking improves study result quality by doing the following:

1) Providing an audit trail of all articles that became eligible for ordering and tracking what was ordered and what came in;

2) Full audit and reporting ensures that critical pieces of evidence are not missed;

3) Reviewers are more effective because they are able to immediately know what full articles have been procured; and

4) Uploaded articles are immediately available for reviewers to read, regardless of their geographic location.

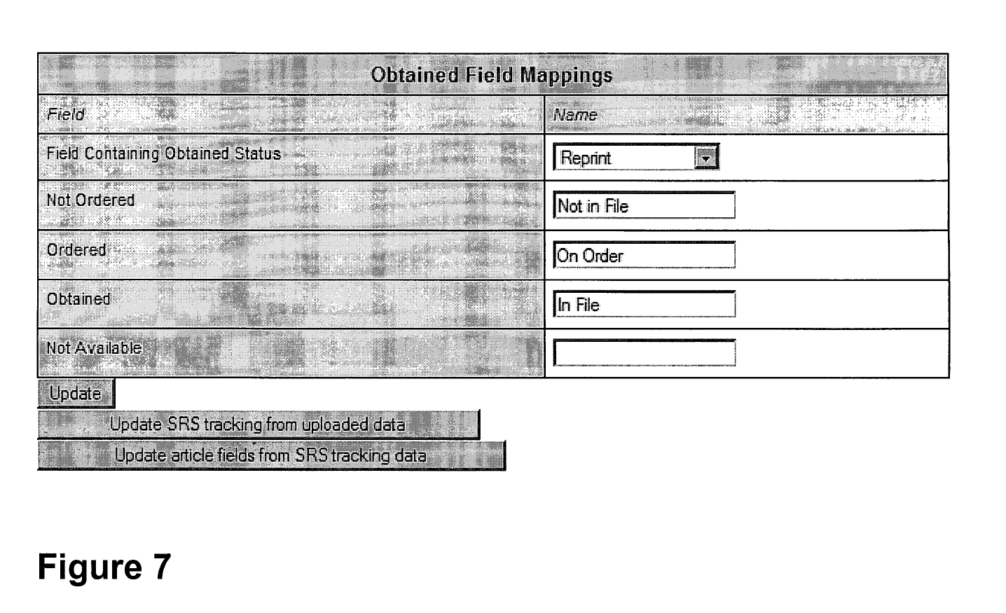

According to an embodiment of the invention, this module may also have a field mapping tool The field mapping tool is a user settable database linkage tool. It allows the binding of updates in one database to updates in another. This keeps both databases in sync automatically and prevents omissions that could be introduced through manual tracking. It also has the benefit of allowing reviewers access to ordering information stored in offline, non-SRS databases that are synced with SRS. An example of a screen display providing a graphical user interface for this aspect of the module may been seen in FIG. 7.

As discussed above, some stand-alone reference management and bibliographic software tools incorporate order tracking. Orders can also be tracked manually on paper or in a database such as Access or Excel. An important aspect of the SRS solution is the integration with the rest of the system. The obtained article tracking module is essentially an interactive report that tells the user what needs to be ordered (based on the automated progress of articles within the study), allows them to track the ordered status and to relay order status back to reviewers through a single interface.

Side-by-Side Full Article Reviewing Module

This module allows a user to view an electronic version of an article in same window as the form containing the review questions. This is possible when the article has been uploaded to the system in electronic form and stored in article database 110. This allows reviewers to work exclusively from electronic versions of documents thus eliminating the need to distribute physical copies.

Articles are uploaded via the obtained article tracking interface described earlier in this document and are stored in the upload field of the article record in the Articles table.

Previously, study participants had to use email or other electronic data transfer mechanisms to share electronic copies of their documents. These mechanisms, however, would not tie the document to its screening form thus introducing the possibility of error and decreasing ease of use.

Side-by-side reviewing reduces the possibility of error by ensuring that the reviewer is completing a form directly associated with a specific article rather than completing a form that may be for a different article.

Side-by-side reviewing also accelerates the screening process by placing the article and the form together so that the review does not need to switch back and forth between the two.

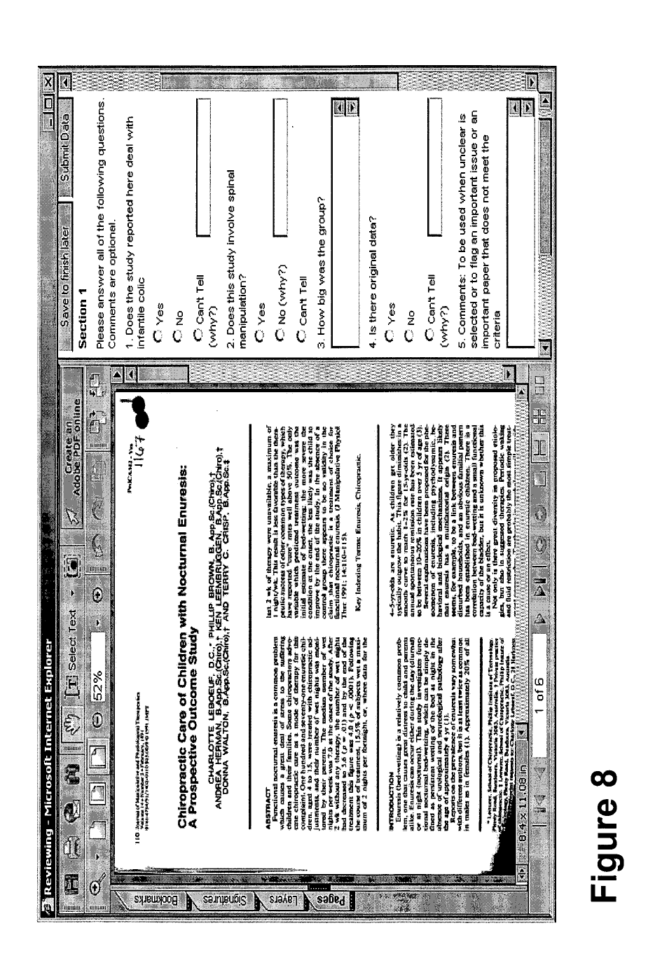

An example of a screen display providing a graphical user interface for this module may been seen in FIG. 8.

Article Display Filter Module

This module provides menus that allow users to select the articles that they wish to view at a given level. Users may select from the following filter criteria:
All Articles
Reviewed
Unreviewed
Conflicts

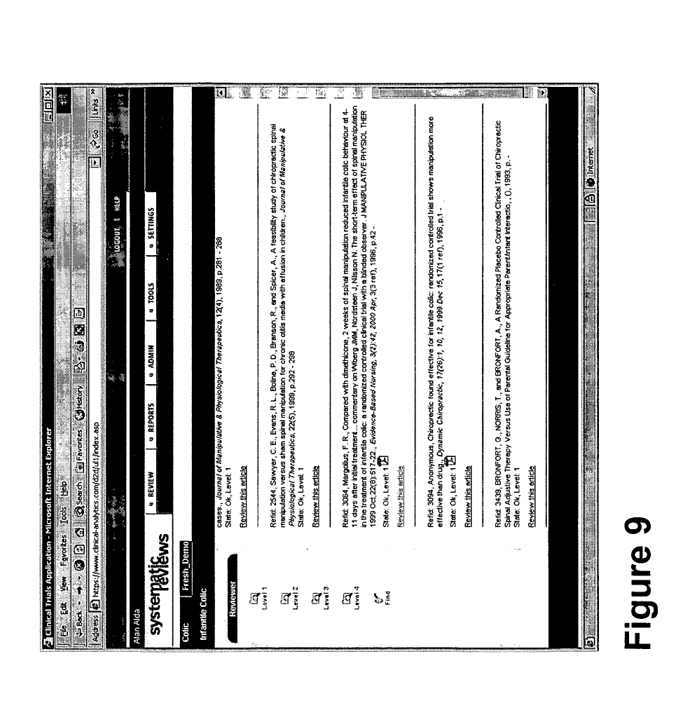

The interface to the filter is a simple drop down box. Once a selection is made, the filter is immediately applied by the article display filter module. An example of a screen display providing a graphical user interface for this module may been seen in FIG. 9.

Article filtering accelerates the process of looking for articles that meet specific criteria. It also reduces error by presenting only the articles that meet the criteria of the task at hand.

Article Reprocess Module

As an ESR progresses it is sometimes necessary to modify the screening forms to correct for protocol errors or omissions. Once a form has been modified it is necessary to re-evaluate the already submitted data from reviewers in light of the new forms to see if the progression of articles is effected. In the current art, this is done by a manual process of comparing the responses of reviewers for each article to the new forms.

The Article Reprocess Module re-evaluates articles against existing reviewer responses using the updated forms and level settings. The module performs this task by first resetting all articles back to the first level of the review and by setting their CurrentLevel field to 1. Then the saved responses of reviewers, stored in the ResponseLink tables, are reapplied to each article, which then progresses or is excluded in the same manner that it would if the reviewers were re-entering their responses into the revised levels.

Article reprocessing allows study administrators to make changes in the forms and level settings and to automatically have the results of those changes propagated the previously reviewed articles. This eliminates the need for reviewers to re-enter their data or to have for form changes manually applied retroactively. This represents significant savings in both time and error rates.

Article reprocessing also allows study administrators to make changes on the fly to perform “what if” analyses. These analyses provide the opportunity of enhancing the designs of their studies.

Article Progress Tracking Module

This module provides a real-time report that displays how many articles that are currently at any given level of a review, how many articles have been reviewed by each of the reviewers at each level and what reviewers have been assigned to each level. In addition, the report displays the number of articles currently being processed at a level, the number of conflicts found, the number of articles completed and the number of articles excluded.

The report is generated dynamically by querying the ResponseLink and ReviewerLink tables and provides a detailed and highly functional snap shot of the status of the review project.

Previously, the method of determining review project status required manual tabulation of data either on paper or in a database such as Excel™. When compared to the instantly available results in SRS, manual data collation is slow, expensive and does not offer the benefits of real time data.

Article progress tracking allows study administrators to track the progress of their study in real time. This allow them to catch reviewer performance issues, study design issues and article quality issues very early on the study while there is still time to correct them. This improves on-time delivery of study results and provides better overall study management with minimal manual effort.

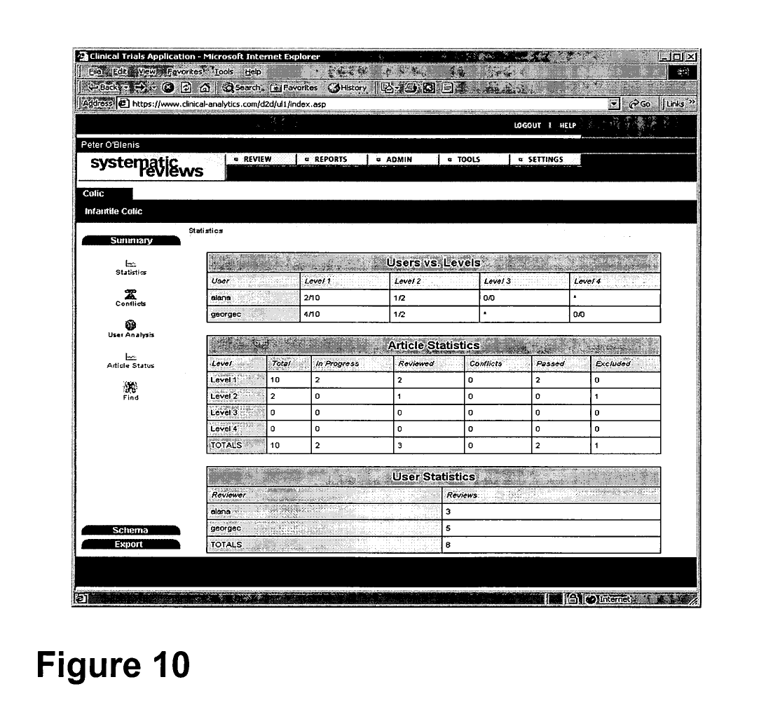

An example of a screen display providing a graphical user interface for this module may been seen in FIG. 10.

Exclusion Reporting Module

An exclusion report is a requirement for many systematic reviews. An exclusion report details what articles were excluded from a study and for what reason or reasons. Creating an exclusion report is a typically a manual process of reviewing the reviewer responses for each excluded article and listing the reasons for exclusion. It is often a requirement to list a primary reason for exclusion. This is done by prioritizing the possible reasons for exclusion and only listing the highest priority reason for each of the excluded articles.

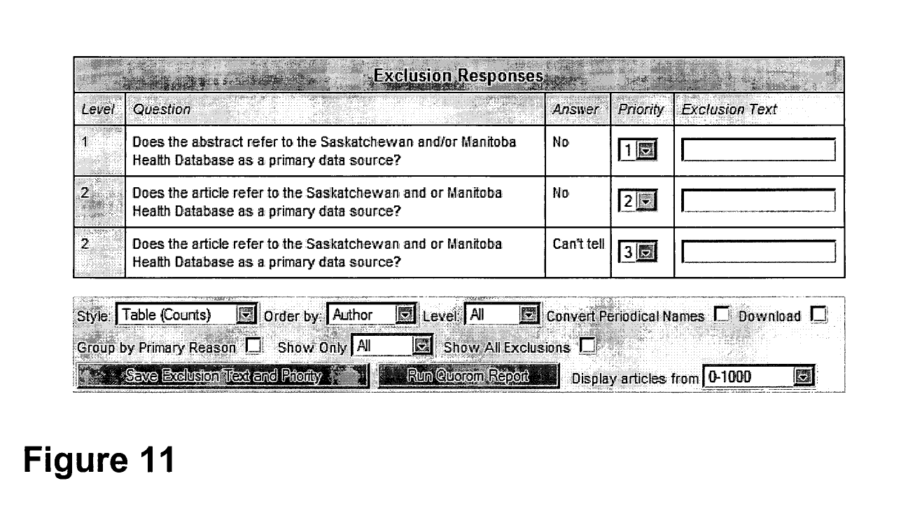

The exclusion reporting module automates the task of generating and exclusion report. The module first inspects each of the electronic forms and presents all of the possible reasons for exclusion to the user. The user may then prioritize the reasons and associate a text description with each reason. An example of a screen display providing a graphical user interface for this aspect of the module may been seen in FIG. 11.

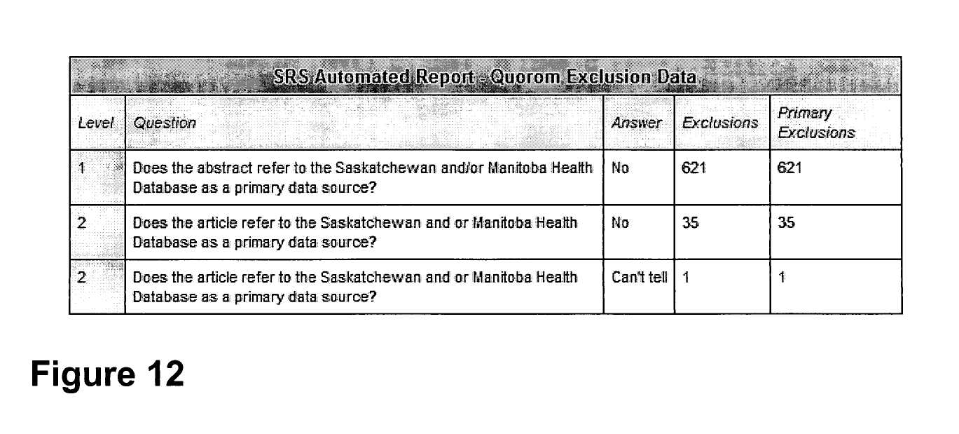

The module generates two types of reports. The first report type lists the number of articles excluded by reason and is generated by querying the Articles and ResponseLink tables. An example of a screen display providing this kind of report may been seen in FIG. 12.

The second report type lists each excluded article in bibliographical output format with the reason for exclusion attached to the reference. These reports may usefully be pasted directly into a document from the display screen. An example of this kind of report is the following bibliographic listing where the bibliographic data is presented followed by the reason (in italics in this example).

HIV/AIDS research priorities among aboriginal people in Canada. Revista Panamericana de Salud Publica/Pan American Journal of Public Health (REV.PANAM.SALUD PUBLICA PAN AM.J.PUBLIC HEALTH ) 5 3, 207-209. 1999; Not associated with the Saskatchewan and/or Manitoba Health Database

Manitoba's money matters. Canadian Pharmaceutical Journal (CAN.PHARM.J.) 124 7, 330+332-1991; Not associated with the Saskatchewan and/or Manitoba Health Database

Manitoba: Renaming the profession. Canadian Pharmaceutical Journal ( CAN.PHARM.J.) 123 7, 308-1990; Not associated with the Saskatchewan and/or Manitoba Health Database

Another year you say? Two-year presidency in Saskatchewan. Canadian Family Physician ( CAN.FAM.PHYS.) 48 December, 1975-2002; Not associated with the Saskatchewan and/or Manitoba Health Database

Saskatchewan Hospital Services Plan: Annual report 1979-80. (66p.) 66p-1980; Not associated with the Saskatchewan and/or Manitoba Health Database

Saskatchewan Hospital Services Plan 1971. Annual report. ABSTR.HOSP.MANAGE.STUD. 9 2 08600, 65-1972; Not associated with the Saskatchewan and/or Manitoba Health Database

Previously, exclusion reports were generated by manual tabulation of data either on paper or in a database such as Excel™. Manual exclusion reports are time consuming and error prone to produce. The SRS significantly reduces the amount of time required to produce a report by automating the majority of the process via the processing of data in the data tables. SRS also reduces the likelihood of introducing errors through manual counts and data transcription.

Conflict Reporting Module

As part of the management of the review project, arrangements must be made for disagreements between reviewers. When two or more reviewers disagree on exclusion reasons for an article, the article can not be promoted to the next level nor excluded from the study. The conflict between reviews must be resolved before the article can be processed.

The conflict reporting module locates all conflicts between reviewer responses and lists them by article, question, answer and reviewer. It does this by querying the Articles and ResponseLink tables. This allows reviewers to quickly determine which other reviewers they have conflicts with and on what questions the conflicts lie.

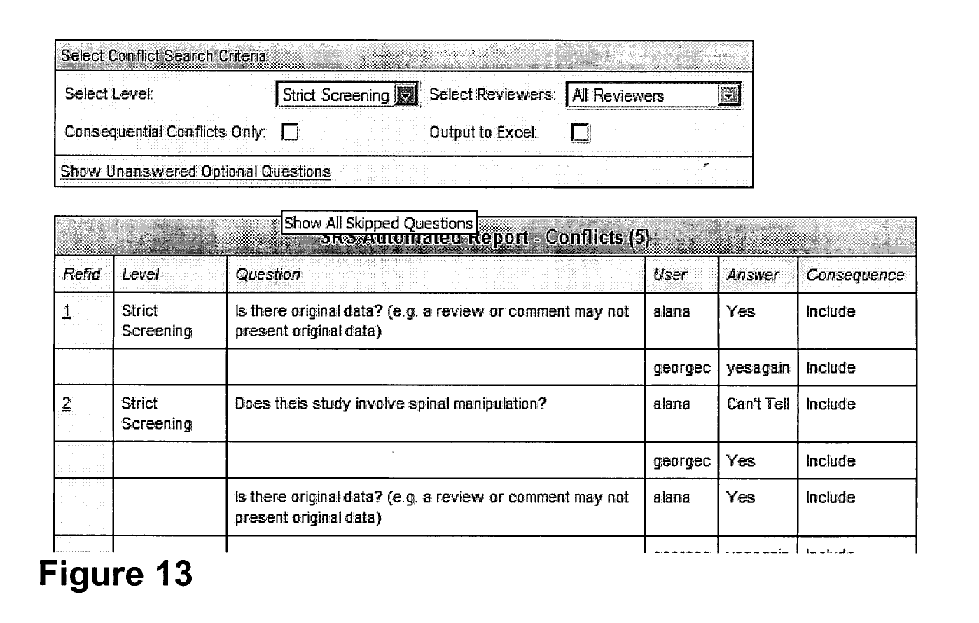

The module works by reviewing the response table for articles that have consequential conflicts; that is conflicts that prevent an article from being processed. The results of this search are displayed on the display screen when the report is generated. An example of a screen display providing this kind of report may been seen in FIG. 13.

With conventional systematic reviews, conflict reports are generated manually by comparing reviewer input. This is normally done by manual tabulation of data either on paper or in a database such as Excel™. These reports are usually then sent to the reviewers for resolution or to a facilitator to arbitrate conflict resolution.

With the automated reports of SRS, no manual intervention is required by the study administrator and there is no manual tallying and comparison of reviewer input. Further, reviewers have the opportunity of resolving conflicts without the necessity of recourse to a higher authority. These aspects of automated conflict report significantly reduce the amount of manual effort required in tracking and resolving conflicts. The automated process also reduces the likelihood that error will be introduced in the process.

Level Form Editor Module

The SRS level form editor provides a means for administrative users to collaboratively build review forms through a web interface. The editor allows the composition of forms using checkbox questions, multiple choice questions and freeform text buttons. It also allows checkbox and multiple choice questions to have a free form text box appended to any response. In addition to questions, the editor allows the addition of section headings and free form descriptions.

For each response to each question in the editor, the user may define the consequence of the question (e.g. if the user selects “no” for question 2 then this article will be excluded. This data is then used to automate the progression of articles as reviewers complete their on-line forms.

The forms defined in the editor are stored in the Questions and Answers tables in the database and are used by the various modules within SRS.

Because the forms are designed and authored within SRS they can be deployed to the reviewers over the network. This greatly facilitates the task of distributing forms to users and also allows changes to be easily made during the course of a study.

By developing study forms online, study administrators can collaborated on their design in real time across geographically separated regions. This typically improves the quality of the forms at the start of the study.

Because changes to the forms are deployed in real time, there is no risk of reviewers using outdated versions and thus submitting invalid data. This reduces errors and improves study efficiency.

The form designer also enforces strict adherence of forms to the ESR methodological design. This improves the consistency of forms and thus results across studies.

The present invention provides a comprehensive method and system which allows a study administrator to implement a systematic review study project by designing forms, deploying forms and articles across a network to study reviewers, monitor and generate reports on the progress of the review project, and make adjustments to the review study's schema by amending the forms and reprocessing review results to that point. Further, it is contemplated that the use of a networked database and web browser access provides the study administrator with the ability to store study project forms and results for future use, as well as “publishing” to other study administrators. This allows, for example, a particular study to be replicated across a different set of reviewers. Alternatively, it may become desirable to run a review that is very similar to an existing completed one. This could be to test a slightly different hypothesis, for example.

A further significant issue facing systematic reviews today is simply keeping them up to date with new publications potentially relevant to the particular study. Because reviews need to incorporate up to date studies to stay relevant, reviews must be periodically reopened and updated. With paper based reviews it is often the case that various pieces of the review become lost or misplaced. Paper forms may be lost or damaged or computer files, typically residing on a desktop computer, may also be lost or stored in an outdated file format. In SRS, most of what is required to re-run the review can be stored in the online system. Reopening an existing review is simply a matter of logging in to the project and making the requisite updates to the articles database and extending the study project by having reviewers process the new articles.

The modules forming the major components of the Systematic Review System have been so described and illustrated in the accompanying figures such that one skilled in the programming arts would be able to reproduce and gain the benefits of the invention. To further supplement the previous description and figures, the source code for an embodiment of the invention is provided.

### Reference to a Computer Program Listing Compact Disk Appendix

A computer program listing appendix is included with this application and the entire contents of the computer program listing appendix is incorporated herein by reference.

Accompanying this application is a single CDROM which contains program listings which implement a preferred embodiment of the invention. The CDROM has 4 subdirectories: “IMAGES”, “INCLUDE”, “common” and “d2d”. Due to the large quantity of files, amounting to a total of 1399 files in all, the specific files in each of the directories and subdirectories are listed in an appendix at the end of this disclosure.

A portion of the disclosure recited in the specification contains material which is subject to copyright protection. Specifically, a Computer Program Listing Appendix in accordance with 37 CFR Section 1.52 is included that lists source code instructions for a process by which the present invention is practiced in a computer system. The copyright owner has no objection to the facsimile reproduction of the specification as filed in the Patent and Trademark Office. Otherwise all copyright rights are reserved.

While the invention has been described in conjunction with specific embodiments thereof, it is evident that many alternatives, modifications, and variations will be apparent to those skilled in the art in light of the foregoing description. Accordingly, it is intended that the present invention be limited not by the specific disclosure herein, but to embrace all such alternatives, modifications, and variations as fall within the spirit and broad scope of the appended claims.

1. A computer mediated system for systematic document review of a defined set of documents on a display device comprising:
means for establishing a set of review levels; and
means for establishing a set of criteria for a document under review to attain a particular level of said set of review levels;
means for establishing a set of electronic review forms;
means for providing to said display device at least one of the set of said set of electronic review forms;
means for entering and storing data entered on said electronic review forms;
means for determining the level attained by said document from the defined set of documents by comparing the data stored to said set of criteria; and
means for reporting on data stored and level attained.

2. A computer mediated system as claimed in claim 1 wherein said computer mediated system is operated over a network.

3. A computer mediated system as claimed in claim 2 wherein said network is the Internet.

4. A computer mediated system claimed in claim 1 wherein said means for establishing a set of review levels and a set of criteria for a document under review to attain a particular level of said set of review levels comprises:
a levels setting module running on a network selected from the group consisting of client-server networks, peer-to-peer networks and networks having disconnected synchronization means.

5. A computer mediated system as claimed in claim 1 wherein said means for establishing electronic review forms comprises:
a form editor module running on a network selected from the group consisting of client-server networks, peer-to-peer networks and networks having disconnected synchronization means.

6. A computer mediated system as claimed in claim 1 further comprising:
means for providing to a reviewer at least one of the set of said set of electronic review forms and an electronic copy of a document from the defined set of documents.

7. A computer mediated system as claimed in claim 6 wherein said means for providing to a reviewer comprises:
a document review module running on a network selected from the group consisting of client-server networks, peer-to-peer networks and networks having disconnected synchronization means.

8. A computer mediated system as claimed in claim 7 wherein said document review module further comprises:
a side-by-side display capability for presenting said electronic review form and at least a portion of said document under review adjacent each other upon said display device.

9. A computer mediated system as claimed in claim 6 further comprising:
a document display filter means for selecting a specific document from said defined set of documents.

10. A computer mediated system as claimed in claim 9 wherein said document display filter means comprises:
an document display filter module running on a network selected from the group consisting of client-server networks, peer-to-peer networks and networks having disconnected synchronization means.

11. A computer mediated system as claimed in claim 1 wherein said means for entering and storing data entered on said electronic review forms comprises:
a data entry device coordinated with said display device; and
memory means associated with a network selected from the group consisting of client-server networks, peer-to-peer networks and networks having disconnected synchronization means.

12. A computer mediated system as claimed in claim 1 wherein said means for determining the level attained by said document from the defined set of documents by comparing the data captured in conjunction with said set of criteria comprises:
a document progression module running on a network selected from the group consisting of client-server networks, peer-to-peer networks and networks having disconnected synchronization means.

13. A computer mediated system as claimed in claim 12 further comprising:
a document reprocessing means having means for changing said set of review levels and said set of criteria for a document under review to attain a particular level of said set of review levels and means for re-determining the level attained by said document from the defined set of documents by comparing the data captured in conjunction with a changed set of criteria.

14. A computer mediated system as claimed in claim 13 wherein said document reprocessing means comprises:
a document reprocessing module running on a network selected from the group consisting of client-server networks, peer-to-peer networks and networks having disconnected synchronization means.

15. A computer mediated system as claimed in claim 1 wherein said means for reporting comprises:
a reporting module running on a network selected from the group consisting of client-server networks, peer-to-peer networks and networks having disconnected synchronization means.

16. A computer mediated system as claimed in claim 15 wherein said reporting module comprises:
a document progress tracking module reporting on the review level attained by a specific document.

17. A computer mediated system as claimed in claim 15 wherein said reporting module comprises:
a document presence module reporting on the availability of a specific document in said defined set of documents.

18. A computer mediated system as claimed in claim 15 wherein said reporting module comprises:
an exclusion reporting module reporting the set of documents from said defined set of documents which have had data entered which satisfy criteria for exclusion.

19. A computer mediated system as claimed in claim 15 wherein said reporting module comprises:
a conflict reporting module reporting the set of documents from said defined set of documents which have had data entered which satisfy criteria for conflict.

20. A method for conducting a review of a defined document set, the method comprising the steps of:
defining a review schema; incorporating the review schema into an electronic review form;
collecting data entered into said electronic review form; and
reporting said collected data.

21. A method for conducting a review of a defined document set as claimed in claim 20 wherein the defining step comprises:
defining a series of at least two review levels, wherein each review level has at least one associated electronic review form, and wherein said series is sequential.

22. A method for conducting a review of a defined document set as claimed in claim 21 wherein each of said review levels comprises one of the group consisting of a screening level and an extraction level.

23. A method for conducting a review of a defined document set as claimed in claim 22 wherein each screening level specifies criteria which when satisfied identifies a particular document under review as being excludable.

24. A method for conducting a review of a defined document set as claimed in claim 21 wherein each extraction level specifies criteria which identifies specific data to be extracted from a particular document under review.

25. A method for conducting a review of a defined document set as claimed in claim 21 wherein the incorporating step uses a form creation module.

26. A method for conducting a review of a defined document set as claimed in claim 21 further comprising the step of providing said electronic review form to a terminal across a network.

27. A method for conducting a review of a defined document set as claimed in claim 26 further comprising the step of providing an electronic copy of a document to be reviewed.

28. A method for conducting a review of a defined document set as claimed in claim 27 further comprising the step of providing an electronic copy of a document to be reviewed to a terminal across a network.

29. A method for conducting a review of a defined document set as claimed in claim 28 further comprising the step of providing a split screen view of said electronic review form and said electronic copy of a document to be reviewed.

30. A method for conducting a review of a defined document set as claimed in claim 29 wherein said split screen view is provided to a terminal across a network.

31. A method for conducting a review of a defined document set as claimed in claim 20 wherein said collecting step is done across a network.

32. A method for conducting a review of a defined document set as claimed in claim 20 wherein said collecting step is followed by the step of:
storing said data into at least one data table.

33. A method for conducting a review of a defined document set as claimed in claim 32 wherein said storing step is followed by the step of:
processing the data stored in said at least one data table according to said review schema.

34. A method for conducting a review of a defined document set as claimed in claim 32 wherein said storing step is followed by the steps of:
reconfiguring said review schema; and processing the data stored in said at least one data table according to the reconfigured review schema.

35. A method for conducting a review of a defined document set as claimed in claim 20 wherein said storing step is followed by the step of:
promoting a reviewed document to a next level according to said stored data and said review schema.

36. A method for conducting a review of a defined document set as claimed in claim 35 wherein said promoting step occurs under a liberal screening level schema.

37. A method for conducting a review of a defined document set as claimed in claim 35 wherein said promoting step occurs under a strict screening level schema.

38. A method for conducting a review of a defined document set as claimed in claim 20 wherein said storing step is followed by the steps of:
excluding a reviewed document from promotion to a next level according to said stored data and said review schema.

39. A method for conducting a review of a defined document set as claimed in claim 20 wherein said storing step is followed by the step of:
flagging a reviewed document as in a state of review conflict according to said stored data and said review schema.

40. A method for conducting a review of a defined document set as claimed in claim 20 wherein said reporting step provides output data relevant to the documents excluded according to said collected data and said review schema.

41. A method for conducting a review of a defined document set as claimed in claim 20 wherein said reporting step provides output data relevant to the documents rendered in a state of conflict according to said collected data and said review schema.

42. A method for conducting a review of a defined document set as claimed in claim 20 wherein said reporting step provides output data relevant to the documents promoted according to said collected data and said review schema.

43. An article of manufacture for conducting a review of a defined document set, the article of manufacture comprising:
at least one processor readable carrier and instructions carried on the at least one carrier; wherein the instructions are configured to be readable from the at least one carrier by at least one processor and thereby cause the at least one processor to operate so as to perform the acts of:
receiving a definition of a review schema;
incorporating the review schema into an electronic review form;
collecting data entered into said electronic review form; and
reporting said collected data.
